(19) United States
(12) Patent Application Publication
(10) Pub. No.: US 2015/0302405 A1
(43) Pub. Date: Oct. 22, 2015

(54) METHOD AND SYSTEM FOR VALIDATION OF MERCHANT AGGREGATION

(71) Applicant: MASTERCARD INTERNATIONAL INCORPORATED, Purchase, NY (US)

(72) Inventor: Jeremy Pastore, Brooklyn, NY (US)

(73) Assignee: MASTERCARD INTERNATIONAL INCORPORATED, Purchase, NY (US)

(21) Appl. No.: 14/256,390

(22) Filed: Apr. 18, 2014

(51) Int. Cl. G06Q 20/40

(52) U.S. Cl. CPC G06Q 20/40

(57) ABSTRACT

A method and system that involve retrieving, from one or more databases, a first set of information including merchant aggregated payment card transaction data for a defined time period, and retrieving, from one or more databases, a second set of information including merchant reported sales data for the defined time period. The method and system further involve analyzing the first set of information and the second set of information to generate a correlation coefficient for the defined time period, and assessing the merchant aggregated payment card transaction data based on the correlation coefficient. The method and system enable validation or verification of merchant aggregation, e.g., determining if merchant aggregation is optimal or above a predetermined threshold value. The method and system leverage consumer payment transaction data and merchant sales information in a way so as to enable validation or verification of merchant aggregation.

### BACKGROUND OF THE DISCLOSURE

1. Field of the Disclosure

The present disclosure relates to a method and a system for the validation or verification of merchant aggregation. In particular, the present disclosure relates to leveraging consumer payment transaction data and merchant sales information in a way that enables validation or verification of merchant aggregation.

2. Description of the Related Art

The term “merchant aggregation” refers to the process of associating merchant identification data (“ID”) with payment transaction data. Inconsistent, inaccurate or incomplete merchant ID data is routinely routed through a payment network (such as MasterCard) and this can hinder analysis efforts and tie up valuable resources in efforts to validate or correct this identification data.

Merchant aggregation works by assigning clean merchant name and address information to transaction data within a payment network. The merchant-relevant data within a transaction record is cleansed using several business rules and text mining capabilities. Merchant brands can then be aligned with several key categories or classifications. The North American Industry Classification System (NAICS) and the Standard Industrial Classification (SIC) system are the most common approaches for this type of classification and are well-established in prior art and common industry practices; among others.

From time to time, it is important to validate or verify that merchant aggregation is optimal. Merchant aggregation is important, for example, in acquiring an understanding of activity across merchants and in driving profitable marketing and product strategies. In addition, merchant aggregation can be used to provide accurate and recognizable merchant identification and location information to help facilitate a number of services and products. Without an effective validation or verification method, determining if merchant aggregation is optimal, can be difficult, if not impossible.

Therefore, a need exists for a method and a system that enable validation or verification of merchant aggregation, e.g., determining if merchant aggregation is optimal.

### SUMMARY OF THE DISCLOSURE

The present disclosure provides a method that involves retrieving, from one or more databases, a first set of information including merchant aggregated payment card transaction data for a defined time period, and retrieving, from one or more databases, a second set of information including merchant reported sales data for the defined time period. The method further includes analyzing the first set of information and the second set of information to generate a correlation coefficient for the defined time period, and assessing the merchant aggregated payment card transaction data based on the correlation coefficient for the defined time period.

The present disclosure also provides a method that further includes retrieving, from one or more databases, a third set of information including merchant geolocation data, analyzing the first set of information and the third set of information to identify one or more associations between the merchant aggregated payment card transaction data and the merchant geolocation data, and updating the merchant aggregated payment card transaction data based on the one or more associations. This method enables more accurate merchant aggregation.

The present disclosure provides a system that includes one or more databases configured to store a first set of information including merchant aggregated payment card transaction data for a defined time period, and one or more databases configured to store a second set of information including merchant reported sales data for the defined time period. The system further includes a processor configured to: analyze the first set of information and the second set of information to generate a correlation coefficient for the defined time period, and assess the merchant aggregated payment card transaction data based on the correlation coefficient.

The present disclosure yet further provides a system that includes one or more databases configured to store a third set of information including merchant geolocation data, and a processor configured to: analyze the first set of information and the third set of information to identify one or more associations between the merchant aggregated payment card transaction data and the merchant geolocation data, and update the merchant aggregated payment card transaction data based on the one or more associations. This system enables more accurate merchant aggregation.

In accordance with the present disclosure, a method and a system are provided that will assign a score to the merchant aggregation profile and provide an objective gauge to determine if merchant aggregation is optimal or above a predetermined threshold value. This scoring method leverages consumer payment transaction data and merchant sales information in a way that enables validation or verification of merchant aggregation. A method and a system are provided that enable more accurate merchant aggregation.

### BRIEF DESCRIPTION OF THE DRAWINGS

FIG. 1 is a diagram of a four party payment card system.

FIG. 2 illustrates the generation of a correlation coefficient from a first set of information including merchant aggregated payment card transaction data for a defined time period, and a second set of information including merchant reported sales data for the defined time period, in accordance with the present disclosure.

FIG. 3 illustrates a data warehouse that is a central repository of data which is created by storing certain transaction data from transactions occurring within four party payment card system if FIG. 1.

FIG. 4 is a flow chart representing a process for validation or verification of merchant aggregation in an embodiment of the present disclosure.

A component or a feature that is common to more than one drawing is indicated with the same reference number in each drawing.

### DESCRIPTION OF THE EMBODIMENTS

Embodiments of the present disclosure are described more fully hereinafter with reference to the accompanying drawings, in which some, but not all, embodiments of the disclosure are shown. Indeed, the disclosure can be embodied in many different forms and should not be construed as limited to the embodiments set forth herein. Rather, these embodiments are provided so that this disclosure clearly satisfies applicable legal requirements. Like numbers refer to like elements throughout.

As used herein, entities can include one or more persons, organizations, businesses, institutions and/or other entities, such as financial institutions, services providers, and the like that implement one or more portions of one or more of the embodiments described and/or contemplated herein. In particular, entities can include a person, business, school, club, fraternity or sorority, an organization having members in a particular trade or profession, sales representative for particular products, charity, not-for-profit organization, labor union, local government, government agency, or political party.

As used herein, the one or more databases configured to store the first set of information or from which the first set of information is retrieved, the one or more databases configured to store the second set of information or from which the second set of information is retrieved, and the one or more databases configured to store the third set of information or from which the third set of information is retrieved, can be the same or different databases.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the present disclosure.

Thus, systems, methods and computer programs are herein disclosed to conduct validation or verification of merchant aggregation. The systems, methods and computer programs involve analyzing a first set of information including merchant aggregated payment card transaction data for a defined time period and a second set of information including merchant reported sales data for the defined time period to generate a correlation coefficient for the defined time period, and assessing the merchant aggregated payment card transaction data based on the correlation coefficient.

Embodiments of the present disclosure will leverage consumer payment transaction data and merchant sales information in a way that enables validation or verification of merchant aggregation. For example, in accordance with this disclosure, a payment card company will have access both to payment card transaction data associated with a merchant, and to merchant sales information (e.g., information retrieved from a Form 10-Q quarterly report, a Form 10-K annual report, or other publicly reported sales data of a merchant), that will enable the payment card company to factor this information into validating or verifying merchant aggregation concerning the particular merchant.

In accordance with the present disclosure, a method of and a system for validation or verification of merchant aggregation are provided. In particular, the present disclosure provides a method and a system for leveraging consumer payment transaction data and merchant sales information in a way that enables validation or verification of merchant aggregation.

The method of this disclosure generally includes retrieving, from one or more databases, a first set of information including merchant aggregated payment card transaction data for a defined time period, and retrieving, from one or more databases, a second set of information including merchant reported sales data for the defined time period. The method further includes analyzing the first set of information and the second set of information to generate a correlation coefficient for the defined time period, and assessing the merchant aggregated payment card transaction data by assigning a score that is primarily based on the correlation coefficient.

In an embodiment, the method of this disclosure further comprises retrieving, from one or more databases, a third set of information including merchant geolocation data, analyzing the first set of information and the third set of information to identify one or more associations between the merchant aggregated payment card transaction data and the merchant geolocation data, and updating the merchant aggregated payment card transaction data based on the one or more associations. This method enables more accurate merchant aggregation.

The system of this disclosure generally includes one or more databases configured to store a first set of information including merchant aggregated payment card transaction data for a defined time period, and one or more databases configured to store a second set of information including merchant reported sales data for the defined time period. The system further includes a processor configured to: analyze the first set of information and the second set of information to generate a correlation coefficient for the defined time period, and assess the merchant aggregated payment card transaction data based on the correlation coefficient.

In an embodiment, the system of this disclosure further comprises one or more databases configured to store a third set of information including merchant geolocation data, and a processor configured to: analyze the first set of information and the third set of information to identify one or more associations between the merchant aggregated payment card transaction data and the merchant geolocation data, and update the merchant aggregated payment card transaction data based on the one or more associations. This system enables more accurate merchant aggregation.

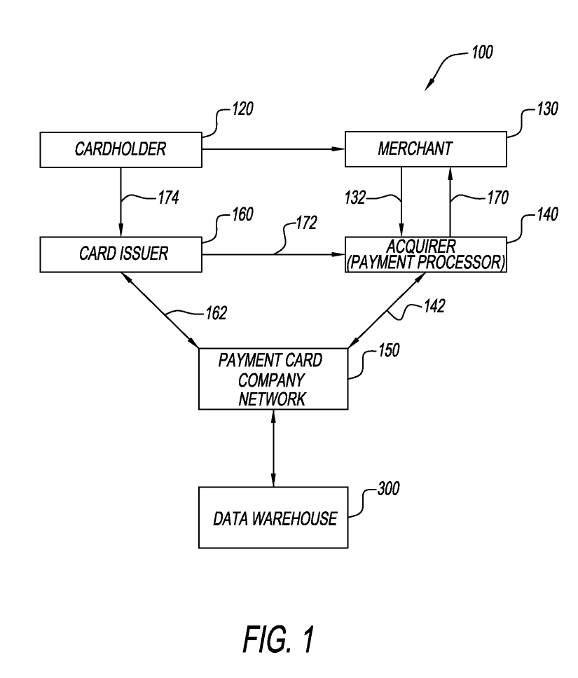

Referring to the drawings and, in particular, FIG. 1, there is shown a four party payment (credit, debit or other) card system generally represented by reference numeral 100. In card system 100, card holder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes the financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, the card holder completes the purchase and receives a receipt.

The account of the merchant 130 is credited, via 170, by the acquirer 140. The card issuer 160 pays, via 172, the acquirer 140. Eventually, the card holder 120 pays, via 174, the card issuer 160.

Data warehouse 300 is a database used by payment card company network 150 for reporting and data analysis. According to one embodiment, data warehouse 300 is a central repository of data which is created by storing certain transaction data from transactions occurring within four party payment card system 100. According to another embodiment, data warehouse 300 stores, for example, the date, time, amount, location, merchant code, and merchant category for every transaction occurring within payment card network 150. In yet another embodiment, data warehouse 300 stores, reviews, and/or analyzes information used in merchant aggregation. In another embodiment, data warehouse 300 aggregates the information by merchant and/or category. In another embodiment, a correlation coefficient is generated from merchant aggregated payment card transaction data and merchant reported sales data for a defined time period in data warehouse 300. In still another embodiment, data warehouse 300 integrates data from one or more disparate sources. Data warehouse 300 stores current as well as historical data and is used for creating reports, performing analyses on the network, merchant analyses, and performing predictive analyses.

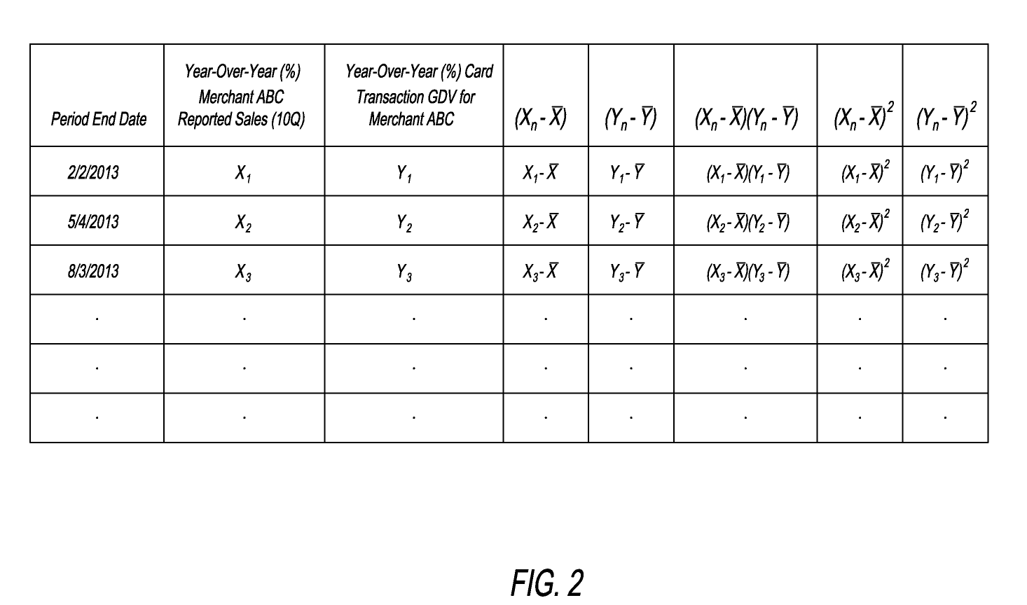

FIG. 2 illustrates the generation of a correlation coefficient from a first set of information including merchant aggregated payment card transaction data for a defined time period, and a second set of information including merchant reported sales data for the defined time period. The correlation coefficient for the defined time period is generated by algorithmically analyzing the first set of information including merchant aggregated payment card transaction data for a defined time period, and the second set of information including merchant reported sales data for the defined time period. An illustrative correlation coefficient generated from a first set of information including merchant aggregated payment card transaction data for a defined time period (notated below as X), and a second set of information including merchant reported sales data for the defined time period (notated below as Y), in accordance with the present disclosure, is shown below:

$$Correl ( X , Y ) = \frac{{\sum }_{t = 1}^{n} ( {X}_{t} - \overline{X} ) ( {Y}_{t} - \overline{Y} )}{\sqrt{{\sum }_{t = 1}^{n} {( {X}_{t} - \overline{X} )}^{2} {\sum }_{t = 1}^{n} {( {Y}_{t} - \overline{Y} )}^{2}}}$$

where X̅ is the average of the seasonally adjusted (year-over-year) gains of card transaction data over n quarters and Y̅ is the average of the seasonally adjusted (year-over-year) gains of merchant reported sales data over n quarters. As shown above, the correlation coefficient is calculated by dividing the covariance of the two time series by the product of their standard deviations.

The correlation coefficient is a measure of the degree to which merchant aggregated payment card transaction data and merchant reported sales data are associated for the defined time period. In particular, the correlation coefficient is a measure of the degree to which gross dollar volume (GDV) of merchant aggregated payment card transactions and gross dollar volume of merchant sales are associated for the defined time period.

Illustrative merchant aggregated payment card transaction data includes, for example, payment card transaction data and merchant data, which have been aggregated by merchant and/or category. Illustrative merchant reported sales data includes, for example, information retrieved from a Form 10-Q quarterly report, a Form 10-K annual report, or other publicly reported sales data of a merchant.

The payment card transaction data includes information related to payment card transactions, for example, purchasing and payment activities attributable to payment card holders, and merchant identification. Payment card transaction data can be obtained, for example, from payment card companies known as MasterCard®, Visa®, American Express®, and the like (part of the payment card company network 150 in FIG. 1).

In particular, the payment card transaction information can contain, for example, a merchant identifier, transaction identifier, geolocation of merchant, geolocation of payment card transaction, geolocation date on which payment card transaction occurred, geolocation time on which payment card transaction occurred, and the like.

In addition to information from a Form 10-Q quarterly report, a Form 10-K annual report, or other publicly reported sales data, merchant information can include, for example, a formal record of the financial activities and a snapshot of a merchant's financial health. Financial statements typically include four basic financial statements, accompanied by a management discussion and analysis. The Balance Sheet reports on a company's assets, liabilities, and ownership equity at a given point in time. The Income Statement reports on a company's income, expenses, and profits over a period of time. Profit & Loss account provide information on the operation of the enterprise. These include sale and the various expenses incurred during the processing state. The Statement of Retained Earnings explains the changes in a company's retained earnings over the reporting period. The Statement of Cash Flows reports on a company's cash flow activities, particularly its operating, investing and financing activities.

While merchant sales information is of primary concern for enabling validation or verification of merchant aggregation, the additional information described above can also be useful in more fully understanding the merchant sales information or contributing to the overall validation or verification of merchant aggregation.

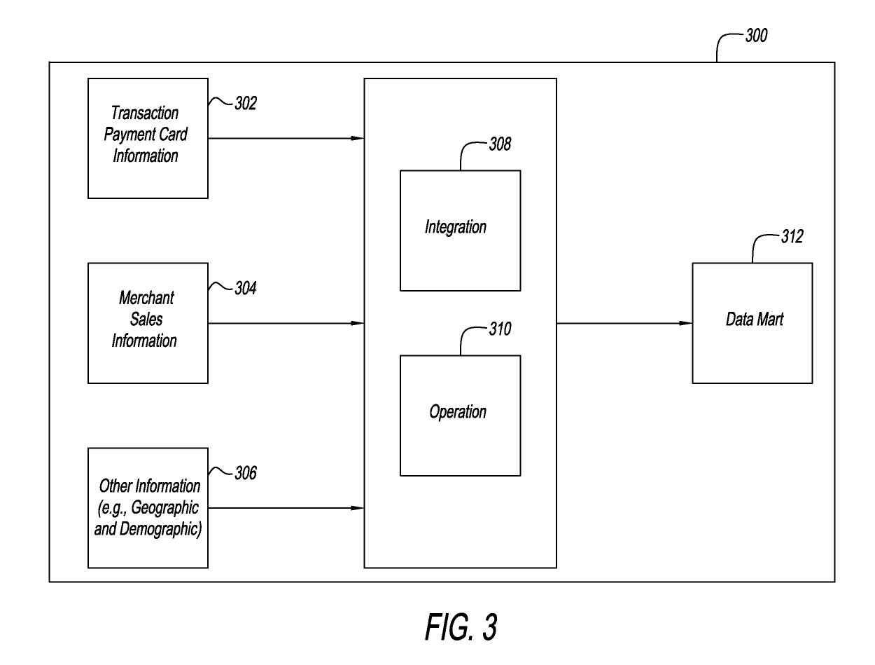

FIG. 3 illustrates an exemplary data warehouse 300 for the storing, reviewing, and/or analyzing of information used for validation or verification of merchant aggregation. The data warehouse 300 can contain a plurality of entries (e.g., entries 302, 304, and 306).

The payment card transaction information 302 can contain, for example, purchasing and payment activities attributable to purchasers (e.g., payment card holders), that is aggregated by merchant and/or category in the data warehouse 300. The merchant sales information 304 includes, for example, information that is retrieved from a Form 10-Q quarterly report, a Form 10-K annual report, or other publicly reported sales data of a merchant. Other information 306 can include demographic or geographic or other suitable information that may be useful in conducting validation or verification of merchant aggregation activities.

The typical data warehouse uses staging, data integration, and access layers to house its key functions. The staging layer or staging database stores raw data extracted from each of the disparate source data systems. The integration layer integrates at 308 the disparate data sets by transforming the data from the staging layer often storing this transformed data in an operational data store database 310. For example, the payment card transaction information 302 can be aggregated by merchant and/or category at 308. Also, the correlation coefficient from merchant aggregated payment card transaction data and merchant reported sales data for a defined time period can be generated in data warehouse 300. The correlation coefficient is then used to assess the merchant aggregated payment card transaction data. The integrated data is then moved to yet another database, often called the data warehouse database or data mart 312, where the data is arranged into hierarchical groups often called dimensions and into facts and aggregate facts. The access layer helps users retrieve data.

A data warehouse constructed from an integrated data source systems does not require staging databases or operational data store databases. The integrated data source systems may be considered to be a part of a distributed operational data store layer. Data federation methods or data virtualization methods may be used to access the distributed integrated source data systems to consolidate and aggregate data directly into the data warehouse database tables. The integrated source data systems and the data warehouse are all integrated since there is no transformation of dimensional or reference data. This integrated data warehouse architecture supports the drill down from the aggregate data of the data warehouse to the transactional data of the integrated source data systems.

The data mart 312 is a small data warehouse focused on a specific area of interest. For example, the data mart 312 can be focused on the correlation coefficient generated from merchant aggregated payment card transaction data and merchant reported sales data for a defined time period and assessment of the merchant aggregated payment card transaction data based on the correlation coefficient. The identified associations can then be used to update the merchant aggregated payment card transaction data. Data warehouses can be subdivided into data marts for improved performance and ease of use within that area. Alternatively, an organization can create one or more data marts as first steps towards a larger and more complex enterprise data warehouse.

This definition of the data warehouse focuses on data storage. The main source of the data is cleaned, transformed, cataloged and made available for use by managers and other business professionals for data mining, online analytical processing, market research and decision support. However, the means to retrieve and analyze data, to extract, transform and load data, and to manage the data dictionary are also considered essential components of a data warehousing system. Many references to data warehousing use this broader context. Thus, an expanded definition for data warehousing includes business intelligence tools, tools to extract, transform and load data into the repository, and tools to manage and retrieve metadata.

Algorithms can be employed to determine formulaic descriptions of the integration of the data source information using any of a variety of known mathematical techniques. These formulas in turn can be used to derive or generate one or more analyses and updates for validation or verification of a merchant aggregation activity using any of a variety of available trend analysis algorithms. For example, these formulas can be used to analyze a first set of information including merchant aggregated payment card transaction data for a defined time period, and a second set of information including merchant reported sales data for the defined time period, to generate a correlation coefficient for the defined time period. These formulas can also be used for assessing the merchant aggregated payment card transaction data based on the correlation.

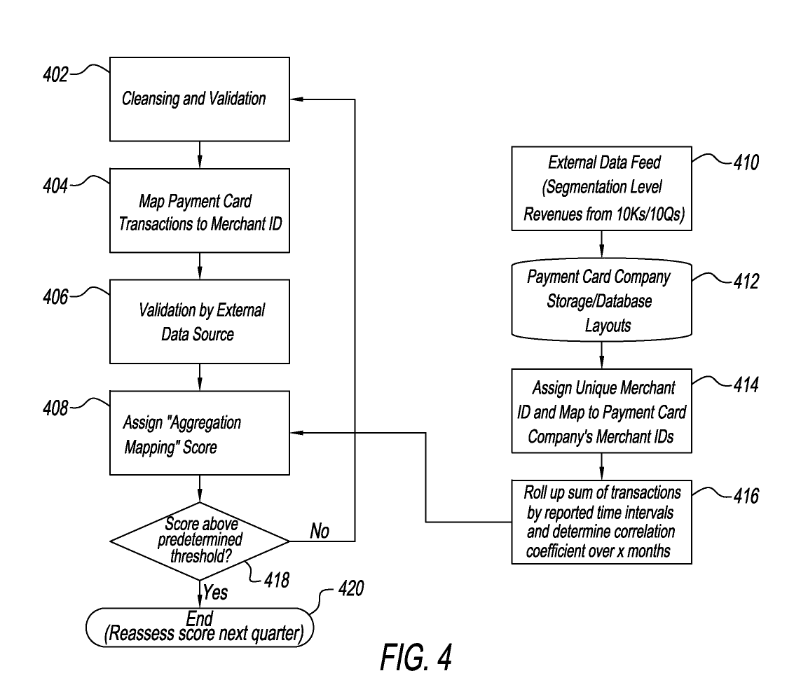

FIG. 4 is a flow chart illustrating validation or verification of merchant aggregation in accordance with this disclosure. A merchant aggregation process is conducted, for example, by a payment card company (part of the payment card company network 150 in FIG. 1). Cleansing and validation of payment card transactions occurs at 402. At 404, mapping of payment card transactions to a merchant identification occurs. The mapping is then validated by an external data source at 406 for any changes that may directly or indirectly affect the merchant identification.

For example, a third set of information including merchant geolocation data is retrieved. The third set of information can be obtained from reporting sources. The first set of information including merchant aggregated payment card transaction data for a defined time period and the third set of information are analyzed to identify one or more associations between the merchant aggregated payment card transaction data and the merchant geolocation data. The merchant aggregated payment card transaction data is then updated based on the one or more associations. The one or more associations comprise at least geolocation of merchant, geolocation of payment card transaction, geolocation date on which payment card transaction occurred, and geolocation time on which payment card transaction occurred.

In accordance with this disclosure, an external data feed including a feed of merchant sales information is obtained by the payment card company at 410. The external data feed can include information from a Form 10-Q quarterly report, a Form 10-K annual report, or other publicly reported sales data of a merchant. The data from the external feed is entered into storage at the payment card company and organized into database layouts at 412. At 414, a unique merchant identification (ID) is assigned to the external data that is then mapped to the payment card company's merchant identifications. At 416, roll up of the sum of payment card transactions by reported time intervals occurs, and a correlation coefficient is determined over a defined period of time.

The correlation coefficient for the defined time period is generated by algorithmically analyzing the first set of information including merchant aggregated payment card transaction data for a defined time period, and the second set of information including merchant reported sales data for the defined time period. As described herein, FIG. 2 illustrates the generation of a correlation coefficient from a first set of information including merchant aggregated payment card transaction data for a defined time period, and a second set of information including merchant reported sales data for the defined time period.

In accordance with this disclosure, the merchant aggregated payment card transaction data is assessed based on the correlation coefficient. The assessment is measure of the degree to which merchant aggregated payment card transaction data and merchant reported sales data are associated for the defined time period, or a measure of the degree to which gross dollar volume of merchant aggregated payment card transactions and gross dollar volume of merchant sales are associated for the defined time period. The first set of information and the second set of information are algorithmically analyzed to generate the correlation coefficient which is used in conducting the assessment.

At 408, a merchant aggregation mapping score is assigned based primarily on the correlation coefficient but could include other independent inputs. If the merchant aggregation mapping score is not above a predetermined threshold 418, then reaggregation of the merchant aggregated payment card transaction data based on the correlation coefficient occurs, beginning again with cleansing and validation at 402. If the merchant aggregation mapping score is above a predetermined threshold 418, then no further action occurs and the merchant aggregation is reassessed the next quarter at 420.

The merchant aggregation mapping score is used as a measure of the degree to which merchant aggregated payment card transaction data and merchant reported sales data are associated for the defined time period. In particular, the merchant aggregation score is a measure of the degree to which gross dollar volume of merchant aggregated payment card transactions and gross dollar volume of merchant sales are associated for the defined time period.

The merchant aggregation mapping score is used for assessing whether or not merchant aggregation is optimal and above a predetermined threshold value. The merchant aggregation mapping score is indicative of the quality of the merchant aggregation, e.g., whether or not the score is above a predetermined threshold.

It will be understood that the present disclosure may be embodied in a computer readable non-transitory storage medium storing instructions of a computer program which when executed by a computer system results in performance of steps of the method described herein. Such storage media may include any of those mentioned in the description above.

Where methods described above indicate certain events occurring in certain orders, the ordering of certain events may be modified. Moreover, while a process depicted as a flowchart, block diagram, and the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

The techniques described herein are exemplary, and should not be construed as implying any particular limitation on the present disclosure. It should be understood that various alternatives, combinations and modifications could be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method comprising:
retrieving, from one or more databases, a first set of information including merchant aggregated payment card transaction data for a defined time period;
retrieving, from one or more databases, a second set of information including merchant reported sales data for the defined time period;
analyzing the first set of information and the second set of information to generate a correlation coefficient for the defined time period; and
assessing the merchant aggregated payment card transaction data based on the correlation coefficient.

2. The method of claim 1, further comprising algorithmically analyzing the first set of information and the second set of information to generate the correlation coefficient for the defined time period.

3. The method of claim 1, wherein the correlation coefficient is a measure of the degree to which merchant aggregated payment card transaction data and merchant reported sales data are associated for the defined time period.

4. The method of claim 1, wherein the correlation coefficient is a measure of the degree to which gross dollar volume of merchant aggregated payment card transactions and gross dollar volume of merchant sales are associated for the defined time period.

5. The method of claim 1, further comprising assigning a merchant aggregation mapping score based on the correlation coefficient.

6. The method of claim 5, further comprising determining if the merchant aggregation mapping score is above or below a predetermined threshold.

7. The method of claim 5, further comprising reaggregating the merchant aggregated payment card transaction data based on the merchant aggregation mapping score.

8. The method of claim 1, wherein the first set of information includes payment card transaction data and merchant data, and optionally geographic and/or demographic information.

9. The method of claim 1, wherein the second set of information is retrieved from a report selected from the group consisting of a Form 10-Q quarterly report, a Form 10-K annual report, and another publicly reported sales data of a merchant.

10. The method of claim 1, wherein the method is carried out by a financial transaction processing entity.

11. The method of claim 1, further comprising:
retrieving, from one or more databases, a third set of information including merchant geolocation data;
analyzing the first set of information and the third set of information to identify one or more associations between the merchant aggregated payment card transaction data and the merchant geolocation data; and
updating the merchant aggregated payment card transaction data based on the one or more associations.

12. The method of claim 1, wherein the one or more associations comprise at least geolocation of merchant, geolocation of payment card transaction, geolocation date on which payment card transaction occurred, and geolocation time on which payment card transaction occurred.

13. A system comprising:
one or more databases configured to store a first set of information including merchant aggregated payment card transaction data for a defined time period;
one or more databases configured to store a second set of information including merchant reported sales data for the defined time period; and
a processor configured to:
analyze the first set of information and the second set of information to generate a correlation coefficient for the defined time period; and
assess the merchant aggregated payment card transaction data based on the correlation coefficient.

14. The system of claim 13, wherein the processor is configured to algorithmically analyze the first set of information and the second set of information to generate a correlation coefficient for the defined time period.

15. The system of claim 13, wherein the correlation coefficient is either a measure of the degree to which merchant aggregated payment card transaction data and merchant reported sales data are associated for the defined time period, or a measure of the degree to which gross dollar volume of merchant aggregated payment card transactions and gross dollar volume of merchant sales are associated for the defined time period.

16. The system of claim 13, further comprising assigning a merchant aggregation mapping score based on the correlation coefficient.

17. The system of claim 16, wherein the merchant aggregation mapping score is determined to be above or below a predetermined threshold.

18. The system of claim 13, wherein the first set of information includes payment card transaction data and merchant data, and optionally geographic and/or demographic information.

19. The system of claim 13, wherein the second set of information is retrieved from a report selected from the group consisting of a Form 10-Q quarterly report, a Form 10-K annual report, and another publicly reported sales data of a merchant.

20. The system of claim 16, wherein the processor is configured to:
reaggregate the merchant aggregated payment card transaction data based on the merchant aggregation mapping score.

21. The system of claim 13, further comprising:
one or more databases configured to store a third set of information including merchant geolocation data; and
the processor is configured to:
analyze the first set of information and the third set of information to identify one or more associations between the merchant aggregated payment card transaction data and the merchant geolocation data; and
update the merchant aggregated payment card transaction data based on the one or more associations.

22. The system of claim 21, wherein the one or more associations comprise at least geolocation of merchant, geolocation of payment card transaction, geolocation date on which payment card transaction occurred, and geolocation time on which payment card transaction occurred.
